(19) United States
(12) Patent Application Publication
(10) Pub. No.: US 2007/0193140 A1
(43) Pub. Date: Aug. 23, 2007

(54) IMPACT RESISTANT DOOR LIGHT

(75) Inventors: Robert Carnick, Sylvania, OH (US); Roswitha M. Jordan, Holland, OH (US)

Correspondence Address: CALFEE HALTER & GRISWOLD, LLP, 800 SUPERIOR AVENUE, SUITE 1400, CLEVELAND, OH, 44114, US

(73) Assignee: TT Technologies, Inc., Edgerton, OH (US)

(21) Appl. No.: 11/560,597

(22) Filed: Nov. 16, 2006

Related U.S. Application Data
(60) Provisional application No. 60/737,705, filed on Nov. 17, 2005.

(51) Int. Cl. E06B 3/00

(52) U.S. Cl. 52/208; 52/455

(57) ABSTRACT

Various door light assemblies are disclosed for withstanding impacts and pressure cycling. Various door light features are disclosed for enhancing structural rigidity of the door light assemblies including insert keys for adjacent frame members, frame geometries and other structural characteristics for withstanding impact loading and pressure cycling. Further, ornamental frames and frame covers are provided for door light assemblies that are sufficient to withstand impact loading and are aesthetic in appearance for utilization in various door light assembly applications.

### CROSS-REFERENCE TO RELATED APPLICATIONS

This application claims the benefit of U.S. provisional application Ser. No. 60/737,705 filed Nov. 17, 2005.

### BACKGROUND OF THE INVENTION

1. Field of the Invention

The invention relates to door lights and more particularly to impact resistant door lights.

2. Background Art

Door lights are often provided within doors for viewing through the door. Since the door light becomes integrated into the structure of the door, the door light will be subjected to loading typical to loading applied to doors. Thus, door lights are subjected to the same testing requirements a door may be subjected to.

Industry and geographic regions have developed specifications for testing doors for withstanding applicable loading. Such tests include impact tests and pressure cycling. These tests are often referred to as hurricane tests, because the tests subject the door to loading that is typical of that applied during a hurricane. Periodically, the testing requirements are increased, thus requiring structural enhancements in doors and door lights.

### SUMMARY OF THE INVENTION

A non-limiting embodiment of the invention provides an impact resistant door light assembly with a window panel sized to be oriented within an aperture of a door. The door light assembly includes a first frame formed of elongated members for mounting the window panel within the door aperture. The first frame is provided with a first region engaging a first surface of the door and a second region engaging a first surface of the window panel. The first frame has a boss extending between the first and second regions and extending within the door aperture between the door and the window panel. A second frame is provided having similar regions for engaging a second surface of the door and a second surface of the window panel. The second frame also includes a boss extending between the first and second regions within the door aperture and oriented between the door and the window panel. A plurality of threaded fasteners cooperate with the first frame boss and the second frame boss for fastening the first frame to the second frame. A plurality of mechanical fasteners are provided securing adjacent frame members of at least one of the frames together for structural enhancement of the door light assembly.

Another non-limiting embodiment of the invention provides an impact resistant door light assembly with a window panel sized to be oriented within an aperture of a door. A first frame is sized to mount the window panel within the door aperture. The first frame has a first region engaging a first surface of the door and a second region engaging a first surface of the window panel. An intermediate region of the first frame includes a boss extending into the door aperture between the door and the window panel. A second frame has a first region and a second region for engaging a second surface of the door and a second surface of the window panel. The second frame has an intermediate region with a boss extending into the door aperture between the door and the window panel. A plurality of fasteners are each provided with a fastener head that engages the first frame intermediate region with a fastener body extending through the first frame boss into the second frame boss for fastening the second frame to the first frame. An external cover is profiled to cooperate with the first frame and is oriented for covering the heads of the fasteners.

Another non-limiting embodiment of the present invention provides an impact resistant door light assembly with a window panel sized to be oriented within an aperture of a door. A first frame is sized to mount the window panel within the door aperture and is provided with a cross section with a first flange engaging a first surface of the door, a second flange engaging a first surface of the window panel, and an intermediate region having a fastener configuration extending into the door aperture between the door and the window panel. The first frame has an external portion extending from the first flange and the second flange for providing a fascia to the door light assembly. The first frame has a hollow region formed between the external portion, the first flange, the intermediate region and the second flange so that the first frame is tubular for structural enhancement of the door light assembly. A second frame is provided adapted to engage a second surface of the door and a second surface to the window panel. The second frame has a fastener configuration that extends into the door aperture between the door and the window panel and cooperates with the first frame fastener configuration for fastening the first frame and the second frame together.

Yet another non-limiting embodiment of the present invention provides an impact resistant door light assembly with a window panel sized to be oriented within an aperture of a door. An extruded first frame mounts the window panel within the door aperture. The first frame has a cross section with a first flange having a contact portion engaging the first surface of the door. The first flange is spaced apart from the door by the contact portion providing a gap for receipt of a sealant. The gap is less than twice a wall thickness of the first flange. A second flange of the first frame engages a first surface of the window panel. A fastener configuration extends from an intermediate region of the first frame into the door aperture between the door and the window panel. A second frame is provided engaging a second surface of the door and a second surface of the window panel with a fastener configuration extending into the door aperture between the door and the window panel for cooperating with the first frame fastener configuration for fastening the second frame and first frame together.

The above aspects, objects, embodiments, benefits and advantages of the present invention are apparent in the attached figures and in the detailed description of embodiments of the invention below.

### BRIEF DESCRIPTION OF THE DRAWINGS

FIG. 1 is a front side elevation view of an embodiment of a door light assembly in accordance with the present invention, illustrated installed in a door;

FIG. 2 is a cross section view of a window panel of the door light assembly of FIG. 1;

FIG. 3 is a cross section view of the door light assembly taken along section line 3-3 in FIG. 1;

FIG. 4 is a cross section view of another embodiment of a door light assembly taken along section line 3-3 in FIG. 1;

FIG. 5 is a partially exploded perspective view of frame members of the door light assembly of FIG. 1;

FIG. 6 is a perspective view of a frame of the door light assembly of FIG. 1;

FIG. 7 is a cross section view of another embodiment of a door light assembly taken along section line 3-3 in FIG. 1;

FIG. 8 is a perspective view of a fastener of the door light assembly of FIG. 7;

FIG. 9 is a perspective view of a frame member of the door light assembly of FIG. 7, illustrated in cooperation with the fastener of FIG. 8;

FIG. 10 is a perspective view of another fastener for the door light assembly embodiment of FIG. 7;

FIG. 11 is a perspective view of a frame of the door light assembly of FIG. 7, illustrated partially assembled and in cooperation with the fasteners of FIG. 10;

FIG. 12 is a cross section view of the door light assembly of FIG. 7, illustrating the cooperation of the fasteners of FIG. 10;

FIG. 13 is a perspective view of the door light assembly of FIG. 7, illustrated partially assembled in cooperation with another fastener; and

FIG. 14 is a cross section view of another embodiment of a door light assembly taken along line 3-3 of FIG. 1.

### DESCRIPTION OF EMBODIMENTS OF THE INVENTION

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

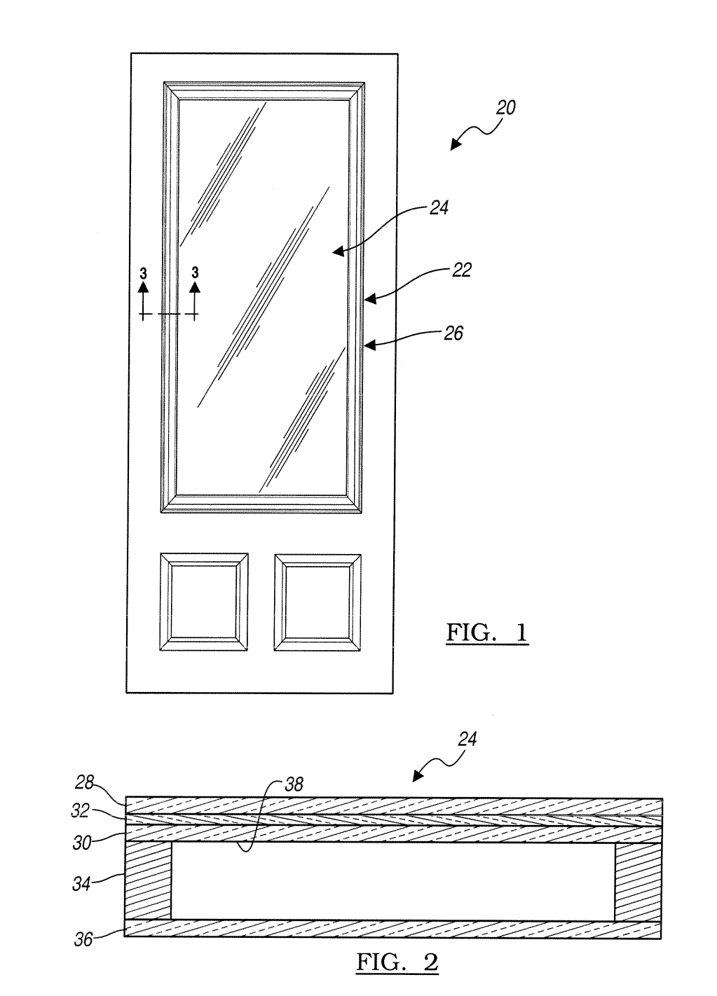

With reference now to FIG. 1, an embodiment of a door assembly is illustrated and referenced generally by numeral 20. The door assembly 20 includes an impact resistant door light assembly 22 installed in the door assembly 20. The door assembly 20 may be any door, residential, commercial or the like, that receives a door light assembly 22 mounted within the door. For example, the door assembly 20 could be a conventional wooden door, a steel door, a molded door, or the like. The door assembly 20 is mounted within a doorway that may be subjected to loading such as impacts, pressure cycling, or other detrimental effects that are generally associated with inclement weather conditions.

Although the door light assembly 22 is illustrated installed into the door assembly 20, the invention contemplates that the door assembly 20 may be provided with a door light assembly 22, or an aperture may be cut into the door assembly 20 and the door light assembly 22 may be installed within the aperture of the door assembly 20.

The door assembly 20 is illustrated from an exterior side of the door assembly 20 in FIG. 1. When viewed from the exterior side, the door assembly 20 appears to be a conventional wooden door with a door light assembly 22. The door light assembly 22 includes a window panel 24 for permitting viewing through the door assembly 20. The door light assembly 22 also includes a frame 26 which provides an appearance of a wooden frame. Likewise, an interior view of the door assembly 20 would be generally similar or identical to the view provided in FIG. 1. Thus, the door light assembly 22 may include a second frame provided on the interior side having a contoured profile to represent conventional wood moldings or frames.

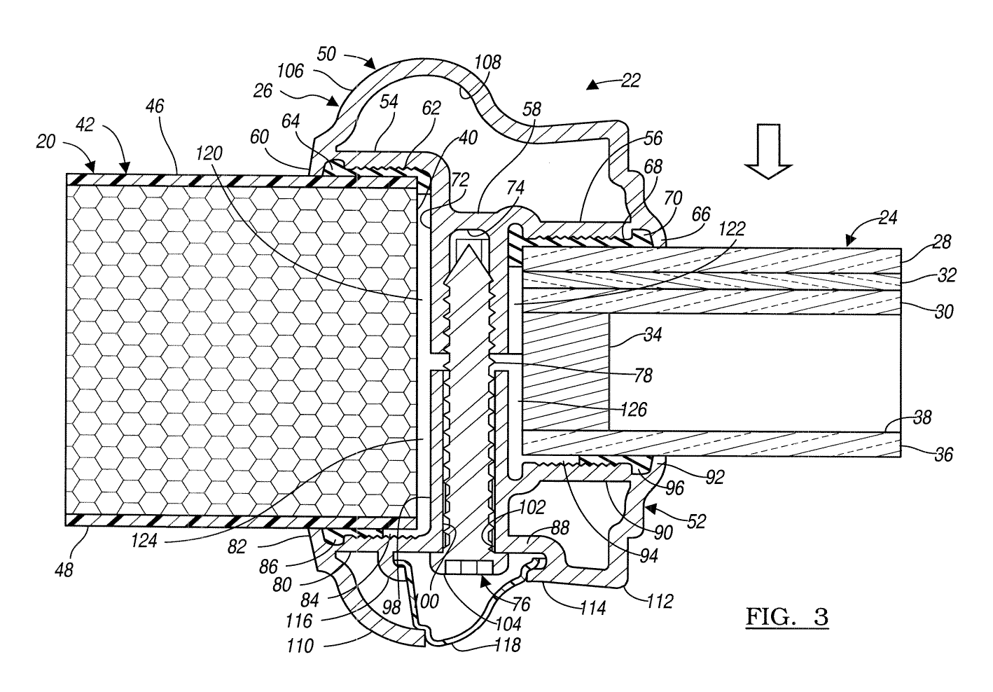

With reference now to FIG. 2, the window panel 24 is illustrated in cross section as, for example, a laminated glass assembly. The window panel 24 may be embodied by any transparent panel, such as a glass panel, composite panel, polycarbonate panel, decorative panel, acrylic panel or the like. The window panel 24 includes a pair of annealed or tempered glass sheets 28, 30. In the embodiment illustrated, the first glass sheet 28 and the second glass sheet 30 are each one-eighth of an inch thick. While these thicknesses are illustrated by way of example, it is understood that any thickness may be utilized within the spirit and scope of the present invention. Displaced between the first glass sheet 28 and the second glass sheet 30 is an interlayer 32, which is formed from a transparent polymeric material, such as polyvinylbutyral (PVB). While in this embodiment, the interlayer 32 is illustrated having a thickness of 0.090 inches, it is understood that any thickness may be utilized. The interlayer 32 provides resiliency to the window panel 24 for preventing breaches through the window panel 24 upon impact or pressure cycling.

The window panel 24 includes a spacer 34 between the second glass sheet 30 and a tempered third glass sheet 36. The spacer 34 may be formed of any suitable material, such as aluminum for spacing a first panel that includes the first glass sheet 28, the interlayer 32 and the second glass sheet 30 from a second panel which includes the tempered third glass sheet 36. The spacer 34 provides a hollow region 38, which insulates the window panel 24. The hollow region 38 may be vacuum sealed, or filled with an inert gas such as nitrogen for insulation. The third glass sheet 36 also has a thickness of one-eighth of an inch providing an overall thickness of the window panel 24 of approximately one inch or less, such as 0.997 inches. The thickness of the third glass sheet 36 and the window panel 24 are disclosed by way of example, and it is understood that any thickness may be provided.

For the embodiment illustrated in FIG. 1, the window panel of 24 is oriented with the first glass sheet 28 facing the exterior so that the first and second glass sheets 28, 30 and the interlayer 32 receive an impact or pressure, if applicable.

Of course, the invention contemplates that the third glass sheet 36 may face the exterior. In an application with the first panel of first and second glass sheets 28, 30 and the interlayer 32 provided on the exterior of the door light assembly 22, each glass sheet 28, 30, 36 may be clear glass. If the tempered third glass sheet 36 is provided on an exterior side of the door light assembly 22, the third glass sheet 36 may be provided with a low-E coating, on an internal surface for reducing an amount of ultraviolet rays that pass through the window panel 24.

With reference now to FIG. 3, a portion of the door light assembly 22 is illustrated enlarged and in section, taken along section line 3-3 from FIG. 1. The door light assembly 22 is illustrated installed within an aperture 40 of the door assembly 20. The door light assembly 22 is illustrated with the frame 26 mounting the window panel 24 within the aperture 40 in the door 20.

A door slab 42 of the door assembly 20 is illustrated in FIG. 3. The door slab 42 may be a portion of a molded door having an internal door core 44 with door skins 46, 48 provided on exterior and interior sides of the door slab 42. Of course, the invention contemplates utilization of other door assemblies.

The frame 26 includes an exterior frame 50 and an interior frame 52. The exterior frame 50 and interior frame 52 each are fastened together to clamp upon the door slab 42 and the window panel 24 for mounting the window panel 24 within the aperture 40 and the door assembly 20.

An aspect of the prior art is to provide door light assembly frames that are contoured similar to wooden moldings. Accordingly, the prior art has provided polymeric or composite frames for securing a glass panel to a door slab. Such prior art frames are typically injection molded. The prior art has also provided extruded frames that are relatively simple in geometry. The simplified geometry of the prior art extruded frames minimizes material costs.

The frame 26 of the door light assembly 22 is formed from extruded aluminum, and includes a relatively complex geometry for replicating a profile of conventional wooden moldings. The first frame 50 is formed from a plurality of extruded aluminum elongate members. The frame members are illustrated as generally linear in FIG. 1, however the members may form any shape, such as arcuate along its length, for providing various styles of door lights.

The exterior frame 50 is provided with a first flange 54 for engaging the door slab 42. The exterior frame 50 is also provided with a second flange 56 for engaging the window panel 24. The first flange 54 and the second flange 56 are connected by an intermediate portion 58. The first flange 54 includes a contact lip 60 formed lengthwise along the first flange 54 for contacting a first surface of the door slab 42. The contact lip 60 spaces the first flange 54 from the door slab 42 for providing a gap 62 therebetween. The gap 62 is provided for receiving a sealant 64. The sealant 64 is retained beneath the first flange 54 by the contact lip 60 and is provided to seal the connection between the first flange 54 and the door slab 42. The sealant 64 preferably is a foam mounting tape or a foam-in-place seal material. Alternatively sealant 64 may be a low modulus sealant such as Sikaflex®-511, which is described in a technical data sheet dated Jun. 21, 2005, which is incorporated in its entirety by reference herein. Of course, the invention contemplates that other tapes, sealants, caulks, adhesives or the like may be provided in the gap 62. For example, an adhesive such as Dow Corning® 995 sealant may be utilized. Additionally, the sealant 64 may be permitted to back fill into the door aperture 40.

The door slab 42 illustrated in FIG. 3 has a thickness of 1.677 inches. Accordingly, the intermediate portion 58 may accommodate the difference in thicknesses between the door slab 42 and the window panel 24 by extending the flanges 54, 56 in stepped parallel relation to one another for appropriate engagement with the door slab 42 and the window panel 24. While in this embodiment a door slab thickness of 1.677 inches is described, it is understood that any thickness may be provided in accordance with the present invention.

The second flange 56 engages a first surface or exterior side of the window panel 24. Likewise, the second flange 56 is provided with a contact lip 66 for engaging the exterior side of the window panel 24 and providing a gap 68 between the second flange 56 and the window panel 24 for receipt of a sealant 70. The sealant 70 may be foam mounting tape or a foam-in-place material, or a low modulus sealant such as Sikaflex®-511 and may be permitted to back fill into the door aperture 40. Alternatively, other seals, tapes, adhesives, caulks or the like may be utilized.

The exterior frame intermediate portion 58 includes a fastener boss 72 extending into the door aperture 40 between the door slab 42 and the window panel 24. The fastener boss 72 provides appropriate spacing and alignment of the window panel 24 relative to the door aperture 40.

The fastener boss 72 is provided by an elongate boss extending along the length of the exterior frame 50. The elongate boss 72 has a channel 74 formed within the boss 72 along the length of the boss 72. The channel 74 receives a series of frame screws 76 along the frame perimeter that fasten the interior frame 52 to the exterior frame 50 for fastening the interior frame 52 to the exterior frame 50 and for clamping the frames 50, 52 to the door slab 42 and to the window panel 24. The frame screw 76 includes a threaded body 78, which is engaged within the channel 74. The frame screw 76 can be formed from a stronger material than the exterior frame 50, such as a steel alloy. The frame screw 76 may be enlarged relative to the channel 74 for threading the frame screw 76 into the channel 74. Alternatively, the exterior frame 50 may be extruded with a tapped region within the channel 74 for receipt of frame screw bodies 78. Alternatively, the channel 74 may be tapped at particular locations that are to receive a frame screw 76.

The interior frame 52 is similar to the exterior frame 50. The interior frame 52 includes a first flange 80 for engaging an interior surface of the door slab 42. The first flange 80 includes a contact lip 82 for contacting the door slab 42 and providing a gap 84 between the first flange 80 and the door slab 42. A seal 86 is provided within the gap 84, which may be a foam tape or a foam-in-place seal material or a low modulus sealant such as Sikaflex®-511, which is described in a technical data sheet dated Jun. 21, 2005, which is incorporated in its entirety by reference herein. Of course, the invention contemplates that other tapes, sealants, caulks, adhesives or the like may be provided in the gap 84. For example, an adhesive such as Dow Corning® 995 sealant may be utilized. An intermediate portion 88 connects the first flange 80 to a second flange 90. The second flange 90 includes a contact lip 92 for contacting an interior side of the window panel 24 and for spacing the second flange 90 from the window panel 24, thus creating a gap 94 between the second flange 90 and the window panel 24. A seal 96 is disposed within the gap 94 for sealing the connection therebetween. The seal 96 may also be a foam tape or a foam-in-place seal material or a low modulus sealant such as Sikaflex®-511, which is described in a technical data sheet dated Jun. 21, 2005, which is incorporated in its entirety by reference herein. Of course, the invention contemplates that other tapes, sealants, caulks, adhesives or the like may be provided in the gap 62. For example, an adhesive such as Dow Corning® 995 sealant may be utilized.

The interior frame 52 includes a fastener boss 98 that extends from the intermediate portion 88 into the door aperture 40 between the door slab 42 and the window panel 24. The boss 98 of the interior frame 52 extends towards the boss 72 of the exterior frame 50. The boss 98 includes a channel 100 formed within for providing clearance to the body 78 of the frame screw 76. An aperture 102 may be formed in the intermediate portion 88 for permitting the body 78 of the frame screw 76 to pass through the intermediate portion 88 and consequently through the boss 98 for threaded engagement within the channel 74 of the boss 72 of the exterior frame 50. The frame screw 76 may include a fastener head 104 that is seated upon the intermediate portion 88 of the interior frame 52. Although, the exterior frame 50 and interior frame 52 may be reversed, it is common within the industry to provide fasteners such as frame screws 76 with the fastener head 104 facing the interior to avoid tampering from the exterior side of the door assembly 20.

The door light assembly 22 is structurally sufficient to withstand applicable loading in an impact direction, which is illustrated by the directional arrow in FIG. 3. The frames 50, 52 sufficiently clamp and maintain the window panel 24 within the door aperture 40 of the door slab 42. Further, the seals 64, 70, 86, 96 are sufficient to prevent loss of pressure between the exterior side and interior side of the door light assembly 22.

The exterior frame 50 also includes a contoured exterior portion 106 that extends from the first flange 54 to the second flange 56. The exterior portion 106 has an arcuate profile for structural enhancement of the exterior frame 50. Additionally, the exterior portion 106 is shaped to represent a conventional profile associated with wooden moldings. Thus, the exterior portion 106 provides a fascia to the exterior frame 50. The exterior portion 106 may be paintable for appearing as painted wood, and may also include a wooden grained pattern knurled into its exterior surface. The external portion 106, first flange 54, intermediate portion 58, and second flange 56 collectively form a tubular frame with a hollow region 108 therein for providing tubular structural rigidity to the exterior frame 50.

The interior frame 52 has an overall ornamental profile similar to that of the exterior cover 50. The interior frame 52 includes a first external portion 110 extending from the first flange 80 and having an arcuate profile that terminates at a distal end spaced apart from and approximate to the intermediate portion 88 for providing clearance for the frame screw 76. Likewise, a second external portion 112 is provided extending from the second flange 90 and terminating with a distal end proximate to the intermediate portion 88 for providing clearance for the frame screw 76. The second external portion distal end forms a gib 114 spaced apart from and proximate to the intermediate portion 88. Likewise, another gib 116 is provided extending from the first flange 80 proximate to the intermediate portion 88. The gibs 114, 116 are spaced transversely for permitting the frame screw 76 to be inserted through the intermediate portion 88.

Additionally, the gibs 114, 116 are profiled to receive an external cover 118 in a pressure-fit engagement. The external cover 118 may be formed from a composite material, including a polymeric material, such as polyvinyl chloride (PVC). The external cover 118 is flexible for manipulating the cover 118 to cooperate within the gibs 114, 116 and cover the fastener heads 104 of the frame screws 76. The external cover 118 spans the perimeter of the interior frame 52 and collectively provides a fascia for the interior frame 52 with the first and second external portions 110, 112. Of course, the invention contemplates that various attachments may be utilized for securing a cover to the frame 52, such as velcro, tape, sliding engagement, transverse sliding engagement, or the like.

An aspect of the prior art is to provide molded frames having counterbored apertures for receiving a frame screw. Accordingly, plugs are provided having a contoured exterior surface for capping the frame screw. A slight angular misplacement of a prior art plug provides an irregular surface to the frame fascia.

The external cover 118 is aligned with the gibs 114, 116 of the interior frame 52 lengthwise for extended alignment lengthwise along the frame 52. Additionally, the seams provided in the fascia extend in an elongate direction along the fascia. Therefore, the seams blend into the aesthetic appearance of the fascia and may be further blended into the ornamental appearance by an application of paint.

The door light assembly of FIG. 3 provides sufficient structural integrity to withstand impacts and pressure cycling associated with modern specifications. Structural rigidity is obtained by utilization of extruded aluminum frames 50, 52 that are sufficiently compact and ornamentally desirable for utilization within residential applications. Prior art frames that are formed from extruded aluminum, may be visually unappealable and therefore are generally limited to commercial applications. Sufficient compactness is obtained by providing the flanges 54, 56, 80, 90 and bosses 72, 98 within close proximity to the exterior geometry of the door slab 42 and the window panel 24. For example, the gaps 62, 68, 84, 94 provided between the flanges 54, 56, 80, 90 and the door slab 42 or window panel 24 are minimal, such as less than twice the wall thickness of the associated flange 54, 56, 80, 90. The frames 50, 52 illustrated in FIG. 3 are formed from extruded aluminum having a generally uniform cross section wall thickness of 0.080 inches. While in this embodiment a cross section wall thickness of 0.080 inches is described, it is understood that any thickness may be employed in accordance with the present invention.

The bosses 72, 98 provide gaps between the bosses 72, 98 and the door slab 42 and the window panel 24. These gaps include a gap 120 between the exterior frame boss 72 and the door slab 42, a gap 122 between the exterior frame boss 72 and the window panel 24, a gap 124 between the interior frame boss 98 and the door slab 42, and a gap 126 between the interior frame boss 98 and the window panel 24. These gaps 120, 122, 124, 126 between the bosses 72, 98 and the door slab 42 and the window panel 24 all generally have a minimal dimension, such as less than twice a wall thickness of the associated boss, such as less than 0.160 inches. Although a minimal gap dimension is provided by example in this embodiment, the invention contemplates any dimension in accordance with the present invention.

The compactness of the door light assembly 22 still provides sufficient engagement with the door slab 42 and the window panel 24. For example, a door bite, which is a dimension of engagement between the exterior frame 50 and the door slab 42 is measured at 0.467 inches from the door aperture 40 to the outermost region of the contact lip 60. Additionally, a glass bite for the exterior frame 50 is measured as 0.595 inches measured from a lateral end of the window panel 24 to an outward portion of the contact lip 66. While in this embodiment, dimensions are provided as an example for the door and glass bite, it is understood that any dimension may be employed within the spirit and scope of the invention.

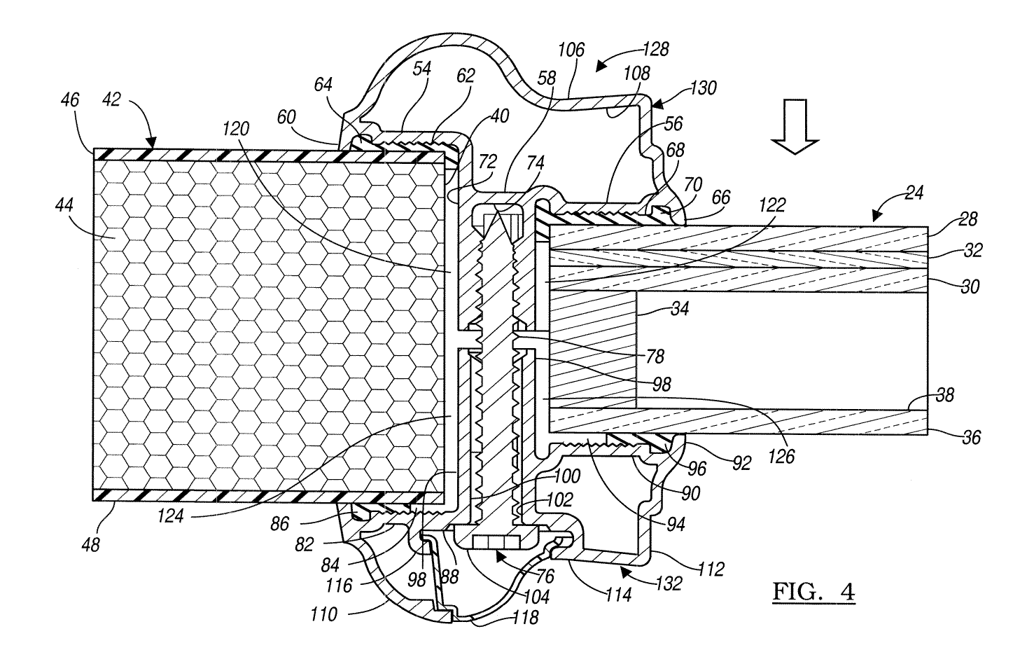

With reference now to FIG. 4, another embodiment of a door light assembly 128 is illustrated in accordance with the present invention. The door light assembly 128 of FIG. 4 is similar in many aspects to the door light assembly 22 of FIG. 3. However, the door light assembly 128 includes an exterior frame 130 and an interior frame 132, each having a uniform wall thickness that is less than the prior embodiment, for example, the frames 130, 132 may each have a uniform wall thickness of 0.055 inches. The door light assembly 128 may be provided for applications that require less structural rigidity. For example, the door light assembly 128 may be provided for applications that are not subjected to extreme inclement weather conditions, such as hurricane conditions. Thus, the door light assembly 128 provides an impact resistant door light assembly that is less costly, but less resistant to impacts in comparison to the prior embodiment.

Referring again to FIG. 1, the frame 26 of the door light assembly 22 may be formed unitary or may include multiple members to match the perimeter of the window panel 24. Accordingly, the members may be mitered at the joints to present a uniform aesthetic appeal. The mitered joints may present weaknesses or points of impact failure in the door light assembly 22. To strengthen the corners the joints maybe welded. To prevent water leakage the corners can be foam filled to provide a rigid water tight frame.

With reference to FIG. 5, a pair of frame members 134, 136 are illustrated being fastened together during an assembly process of the door light assembly 22. An insert key 138 is provided for joining the frame members 134, 136 together. Since the frame members 134, 136 meet at a corner, the insert key 138 is a corner key having a first body portion (not shown) and a second body portion 140 with an included angle therebetween that is sized to match the angle of the joint of the frame members 134, 136.

The body portions 140 of the insert key 138 are sized to be received within the channel 74 of adjacent frame members 134, 136. Once the insert key 138 is received within the channel 74 of the frame members 134, 136, the boss 72 of each frame member 134, 136 is deformed with the insert key 138 for staking the boss 72 of each frame member 134, 136 to the insert key 138. The deformation of the boss 72 provides a mechanical interlock through adjacent frame members 134, 136 and the insert key 138. Once the frame members 134, 136 and insert key 138 are assembled, the joint is inserted into a staking machine which provides the mechanical deformation that interlocks the boss 72 and the insert key 138.

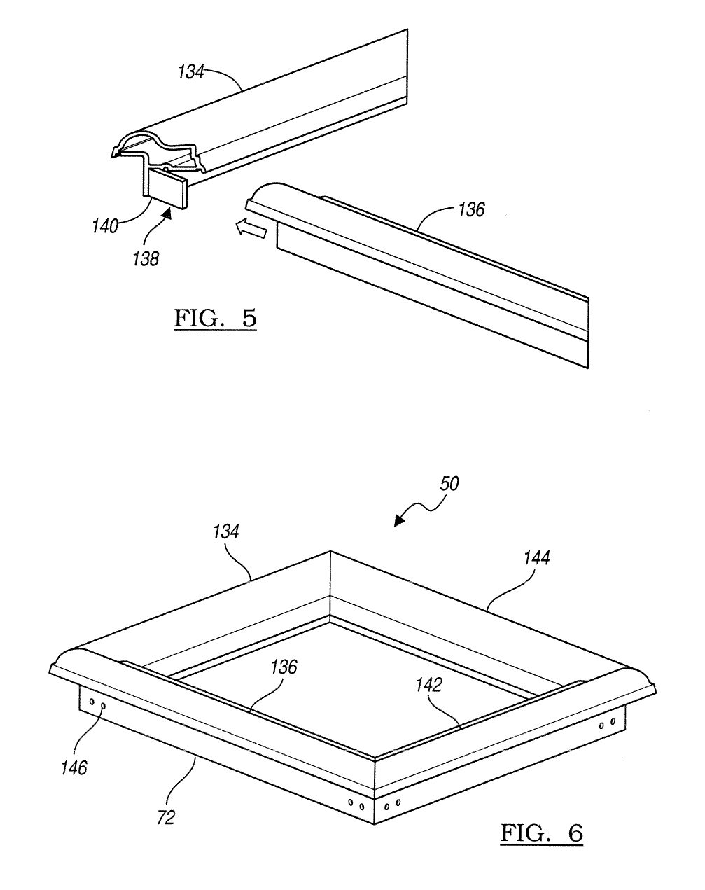

Referring now to FIG. 6, an exterior frame 50 is illustrated with frame members 134, 136, 142, 144 assembled by the method described with reference to FIG. 5. The bosses 72 are illustrated with dimples 146 formed therein as a result of the staking operation.

The insert key 138 may be formed from an aluminum alloy similar to that from which the frame members 134, 136 are extruded. Alternatively, the insert key 138 may be formed from a composite material, such as a polymeric material that is injection molded. Further, the body portions 140 of the insert key 138 may be oversized relative to the channel 74 for providing a press fit of the insert key 138 within the channel 74. For example, the channel 74 has a width of 0.124 inches. Accordingly, the insert key 138 may have a thickness of 0.135 inches for providing a press fit interlock between the insert key 138 and the frame members 134, 136. While a channel width of 0.124 inches and an inert key thickness of 0.135 inches are disclosed by example, it is understood that any dimension may be employed.

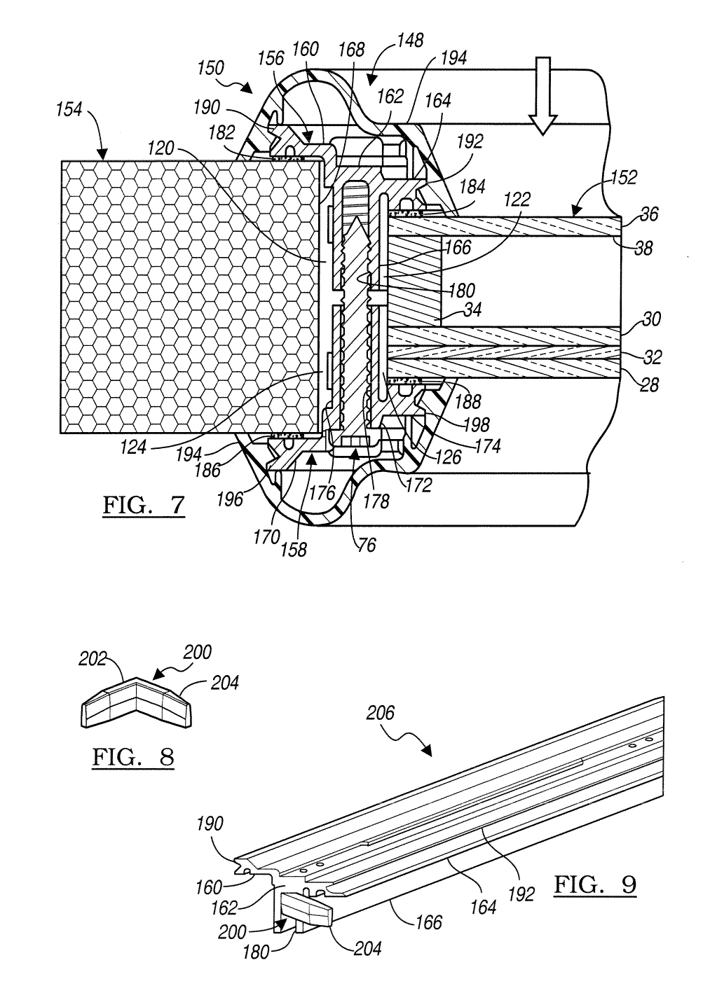

Referring now to FIG. 7, another embodiment of a door light assembly 148 is illustrated in accordance with the teachings of the present invention. The door light assembly 148 is illustrated in cross section, taken along section line 3-3 in FIG. 1. The door light assembly 148 includes a frame 150 for mounting a window panel 152 to a door slab 154. An impact direction is indicated by a directional arrow in FIG. 7, thus indicating an exterior side of the door light assembly 148. Unlike prior embodiments, the window panel 152 is illustrated with a first glass sheet 28 facing an interior side of the door light assembly 148 and with a third glass sheet 36 facing an exterior side of the door light assembly 148. The invention contemplates utilization of a window panel regardless of orientation. A laminated glass assembly is adequate for withstanding the impact, insulation and transparent design characteristics provided for the door light assemblies disclosed herein.

The frame 150 of the door light assembly 148 includes an exterior frame 156 and an interior frame 158. The exterior frame 156 includes a first flange 160 engaging a first surface of the door slab 154, an intermediate portion 162 connected to the first flange 160, a second flange 164 extending from the intermediate portion 162 and engaging a first surface of the window panel 152, and a boss 166 extending within a door aperture 168 between the door slab 154 and the window panel 152. Likewise, the interior frame 158 includes a first flange 170 engaging a second surface of the door slab 154, an intermediate portion 172 connected to the first flange 170, a second flange 174 extending from the intermediate portion 172 for engaging a second surface of the window panel 152, and a boss 176 extending from the intermediate portion 172 into the door aperture 168 between the door slab 154 and the window panel 152. A series of frame screws 76 are provided extending through a channel 178 in the interior frame boss 176 and threadably engaged within a channel 180 of the exterior frame boss 166. The frame screws 76 fasten the exterior frame 156 and interior frame 158 together, thereby clamping the frames 156, 158 to the door slab 154 and to the window panel 152 for orienting the window panel 152 within the door aperture 168.

A seal 182 is provided between the exterior frame first flange 160 and the door slab 154. The seal 182 may be a foam tape for sealing the connection. A seal 184 may be provided between the exterior frame second flange 164 and the window panel 152 for sealing the connection therebetween. The seal 184 may be a glazing compound, a foam tape, a caulking compound, an adhesive, or the like. A seal 186 may be provided between the interior frame first flange 170 and the door slab 154 for sealing the interconnection therebetween. The seal 186 may be a foam tape. A seal 188 is provided between the interior frame second flange 174 and the window panel 152. The seal 188 may be a structural adhesive such as the Dow Corning® 995, SikaFlex® 552 or the like.

Unlike the prior embodiments, the exterior frame 156 is provided with a pair of laterally outboard gibs 190, 192. An external cover 194 is provided with an interior profile sized to slide beneath the gibs 190, 192. The external cover 194 may be snapped over the external frame 156 and may provide a pressure fit with the gibs 190, 192. The external cover 194 covers the unornamented exterior frame 156 and provides an ornamental appearance that mimics wood and molding. Likewise, the interior frame 158 includes a pair of laterally outboard gibs 196, 198 formed on the first flange 170 and second flange 174 respectively. The gibs 196, 198 also receive the external cover 194 for providing an aesthetic ornamental appearance that mimics wood. The external covers 194, may be formed from a resilient material for a pressure fit engagement with the frames 156, 158. For example, the external cover 194 may be molded or extruded from a composite material, such as PVC.

The frame 150 of the door light assembly 148 may utilize the insert keys and staking method illustrated in FIGS. 5 and 6 for fastening adjacent frame members together end to end. With reference now to FIG. 8, another insert key 200 is illustrated in accordance with the present invention. The insert key 200 includes a first body portion 202 and a second body portion 204 each sized to be received within a channel, such as channel 180, of adjacent frame members. The insert key 200 is formed from a composite material such as a polymeric material, including injection molded PVC. Accordingly, the insert key 200 may be formed with tapers on the distal ends of the first body portion 202 and the second body portion 204 for facilitating alignment during assembly of adjacent frame members. The first body portion 202 and the second body portion 204 are illustrated with an included angle therebetween, such as ninety degrees for connecting adjacent frame members that are oriented at a right angle. Of course, the invention contemplates any included angle or no angle for securing adjacent frame members.

With reference now to FIG. 9, the insert key 200 is illustrated with the first body portion 202 inserted within a channel 180 of a boss 166 of a frame member 206 of the exterior frame 156. The insert key 200 includes a thickness of 0.135 inches, which is oversized relative to a width of the channel of 0.124 inches. Thus, the first body portion 202 of the insert key 200 is press fit within the channel 180 thereby providing a fastened connection therebetween. As discussed with the prior embodiment, any thickness may be employed.

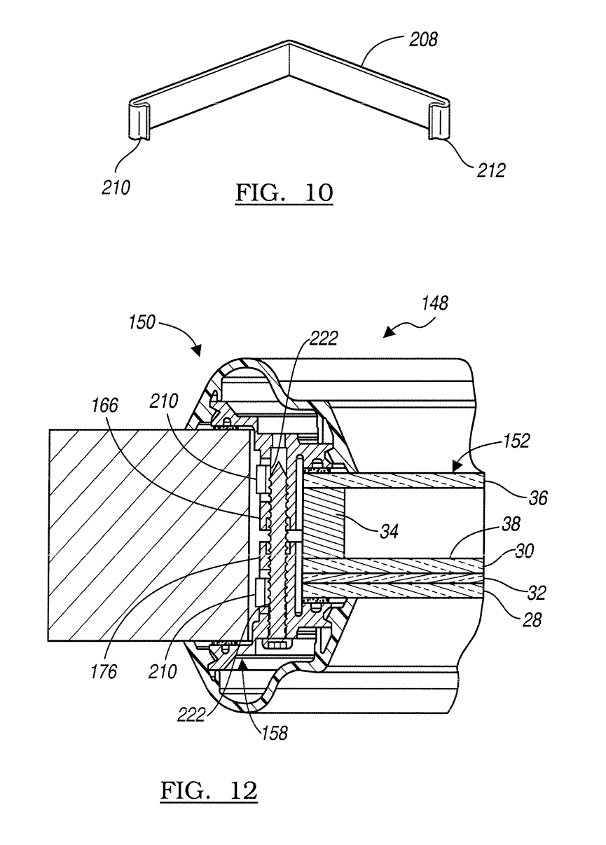

Alternatively, adjacent frame members may be fastened together by utilization of bracketry. Referring now to FIG. 10, a retaining bracket 208 is illustrated in the shape of an L-shaped bracket with a pair of retaining clips 210, 212 formed at distal ends of the bracket 208. The retaining bracket 208 may be formed from a stamped metal, such as a spring steel. With reference now to FIG. 11, the exterior frame 156 of the door light assembly 148 of FIG. 7, is illustrated with adjacent frame members 214, 216, 218, 220 each interconnected at joints therebetween by a retaining bracket 208. Each of the frame members 214, 216, 218, 220 includes an aperture 222 formed within a side wall of the boss 166 for receipt of one of the retaining clips 210, 212 of the retaining bracket 208. Accordingly, the frame members 214, 216, 218, 220 may be assembled by aligning adjacent ends and fastening the adjacent ends together by snapping the retaining clips 210, 212 into the apertures 222.

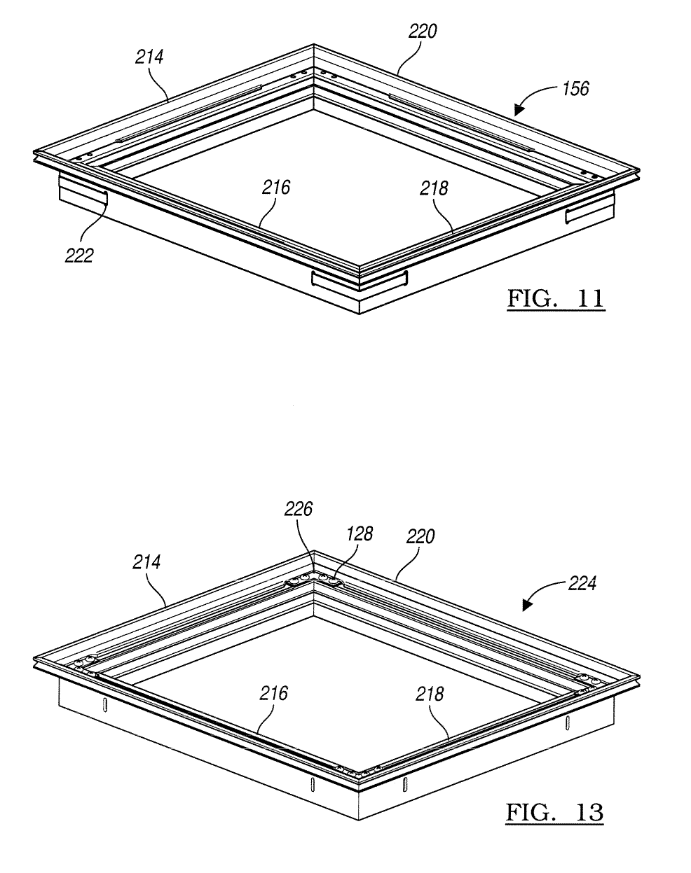

With reference now to FIG. 12, the door light assembly 148 of FIG. 7 is illustrated along a section line that intersects the apertures 122 to illustrate the retaining clip 210 of one of the retaining brackets 208 extending within the aperture 222. Likewise, the interior frame 158 is also illustrated in cooperation with a retaining clip 210 of a retaining bracket 208 for securing adjacent frame members of the interior frame 158 together.

Referring now to FIG. 13, an alternative exterior frame 224 is illustrated having support brackets 226 displaced along the intermediate regions 162 for supporting an intersection of adjacent frame members 214, 216, 218, 220. Threaded fasteners 228 are provided securing the support brackets 226 to the frame members 214, 216, 218, 220. Accordingly, various fastener arrangements may be provided for securing adjacent frame members of the frames of the door light assemblies. Alternatively, adjacent frame members 214, 216, 218, 220 may be welded together for fastening the intersections of the frames. Although the welding may detract from an ornamental appearance of the frame, such as the frame 224, the external cover 194 spans the perimeter of the frame 224 and therefore would cover the welds between the adjacent frame members 214, 216, 218, 220.

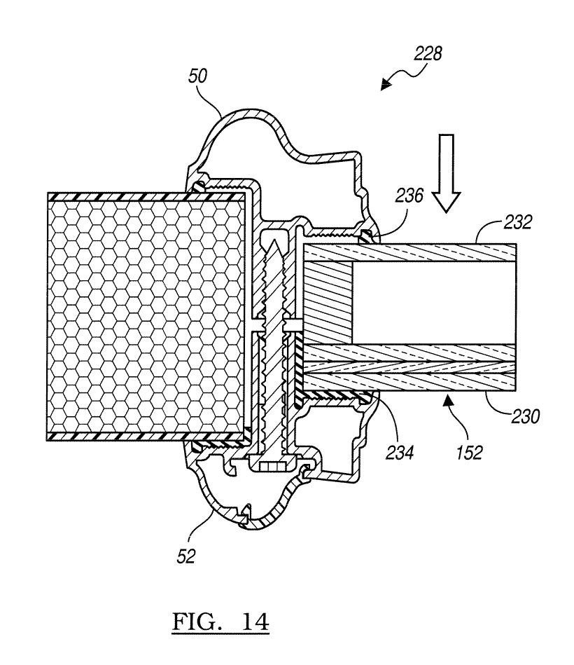

While the earlier embodiments shown in FIGS. 1-13 employ various features of the invention, FIG. 14 illustrates a commercial door light embodiment. FIG. 14 illustrates a door light assembly 228 which utilizes an exterior frame 50 and an interior frame 52 as shown and described with reference to FIGS. 2 and 3. This embodiment has an IGU window panel 152 as described previously in FIG. 12. The inner layer 230 of the laminated glass panel faces toward the inside of the building with the outside of the window unit formed by a single layer of tempered glass 232. The window unit is securely bonded to the inner frame member 52 by an adhesive 234, such as the Dow Corning® 995, SikaFlex® 552 or the like, which when cured securely bonds the peripheral edge of laminated glass sheet 230 to the inner window frame 52. The outer frame member to glass joint is sealed by a foam-in-place material 236.

If the window is struck from the exterior by a missile projectile during an extreme weather condition such as a hurricane, the exterior glass panel 232 will shatter and fall away. The inner layer 230 of the laminated glass will fracture but, will be held together by the PVB inner layer and retained in the window opening by sealant adhesive 234 bonding the periphery of the laminated glass panel 152 to the inner window frame 52. The adhesive 234 will not only withstand the initial missile impact load but further withstand the cyclic loads due to pressure pulsations during a storm thereby reducing the likelihood of the external wind load from pressurizing the building through a fractured window opening.

The exterior glass panel 232 is sealed to the outer frame 50 by a sealant 236. Preferably sealant 236 is a foam-in-place composition such a hot melt polyolefin designed for glazing and sealing made by Bostik, Inc. of Huntingdon Valley, Pa. (product number HX9433 HO1).

Outer frame 50 and inner frame 52 are preferably formed of aluminum extrusions which are cut to the length to form mitered corners. Four frame lengths which form an inner or outer frame can be held together utilizing mechanical fasteners as shown in FIG. 10 and described previously, or welded together preferably at an inside location where the weld would not be visible. Corner regions of the tubular frame members are preferably filled with a foam material in order to provide a water tight frame where water cannot enter through the mitered joint.

In summary, various features are disclosed for providing an impact resistant door light assembly that meets applicable modern loading criteria, while providing an ornamental door light assembly that may be utilized for residential and/or commercial applications.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An impact resistant door light assembly comprising:
a window panel sized to be oriented within an aperture of a door;
a first frame sized to mount the window panel within the door aperture, the first frame having a first region adapted to engage a first surface of the door, the first frame having a second region adapted to engage a first surface of the window panel, the first frame having an intermediate region between the first region and the second region, the first frame having a boss extending from the intermediate region into the door aperture, between the door and the window panel;
a second frame sized to mount the window panel within the door aperture, the second frame having a first region adapted to engage a second surface of the door, the second frame having a second region adapted to engage a second surface of the window panel, the second frame having an intermediate region between the first region and the second region, and the second frame having a boss extending from the intermediate region into the door aperture, between the door and the window panel and an elongate open channel aligned with the boss opening outwardly in a direction away from the boss;
a plurality of fasteners for insertion in the channel in the first frame, each fastener having a fastener head for engaging the first frame intermediate region, and a fastener body extending through the first frame boss into the second frame boss, the fastener bodies each cooperating with the second frame boss for fastening the second frame to the first frame; and
an elongate external cover profiled to cooperate with the open channel formed in the first frame for covering the heads of the plurality fasteners.

2. The impact resistant door light assembly of claim 2 wherein the external cover encircles the entire perimeter of window panel.

3. The impact resistant door light assembly of claim 1 wherein the external cover is affixed to the first frame by a pressure-fit engagement.

4. The impact resistant door light assembly of claim 1 wherein the first frame further comprises a pair of gibs and the external cover cooperates with the pair of gibs for affixing the external cover to the first frame.

5. The impact resistant door light assembly of claim 4 wherein the pair of gibs are oriented adjacent the intermediate region and the external cover is provided generally over the intermediate region.

6. The impact resistant door light assembly of claim 1 wherein the window panel comprises:
an insulating glass unit having a spaced apart outer glass sheet and an interior laminated glass sheet formed of at least one glass layer bonded to a flexible polymer layer; and
the impact resistance door light assembly further comprising a high strength adhesive foam layer bonding a peripheral edge of the laminated glass sheet to one of the first and second frames which is oriented toward the interior of a building to which the door is attached.

7. The impact resistant door light assembly of claim 1 wherein each of the first and second frames each comprise:
a plurality of elongate frame members sized to cooperate in end to end relation to mount the window panel within the door aperture; and
a plurality of mechanical fasteners securing adjacent ends of the frame members together.

8. The impact resistant door light assembly of claim 7 wherein each mechanical fastener further comprises a bracket adapted to be fastened to adjacent frame members.

9. The impact resistant door light assembly of claim 7 wherein the ends of the first and second frame members provide an open socket for receiving a mechanical fastener.

10. The impact resistant door light assembly of claim 9 wherein the mechanical fasteners further comprise a plurality of insert keys each having a first and second body portion sized to be received within open sockets formed in adjacent frame member ends for fastening adjacent frame members together.

11. The impact resistant door light assembly of claim 10 wherein the frame members are locally deformed to mechanically interlock the open socket and the insert keys.

12. The impact resistant door light assembly of claim 10 wherein the first and second frame members are formed from an extruded metal and the insert keys are formed from a similar metal.

13. The impact resistant door light assembly of claim 10 wherein each insert key first body portion and second body portion are sized to be press fit into the open socket in the frame member ends.

14. The impact resistant door light assembly of claim 10 wherein each insert key is formed from a composite material.

15. The impact resistant door light assembly of claim 14 wherein the composite material is further defined as a polymeric material.

16. The impact resistant door light assembly of claim 10 wherein the open socket is formed within the boss portion of each of the frame members.

17. The impact resistant door light assembly of claim 10 wherein the window panel comprises:
an insulating glass unit having a spaced apart outer glass sheet and an interior laminated glass sheet formed of at least one glass layer bonded to a flexible polymer layer; and
the impact resistance door light assembly further comprising a high strength adhesive foam layer bonding a peripheral edge of the laminated glass sheet to one of the first and second frames which is oriented toward the interior of a building to which the door is attached.

18. The impact resistant door light assembly of claim 7 wherein the corner regions formed by adjacent frame member ends are filled with a foam-in-place sealant to create a water tight joint.
